(19) United States
(12) Patent Application Publication
(10) Pub. No.: US 2021/0178331 A1
(43) Pub. Date: Jun. 17, 2021

(54) ULTRAFILTRATION SYSTEM FOR ADVANCED TREATMENT OF COAL MINE WATER

(71) Applicant: Shanxi Tieju Eco-Space Co. LTD, Taiyuan (CN)

(72) Inventors: Ruikui DU, Taiyuan (CN); Fuqiang AN, Taiyuan (CN); Yutian ZHANG, Taiyuan (CN)

(73) Assignee: Shanxi Tieju Eco-Space Co. LTD, Taiyuan (CN)

(21) Appl. No.: 17/119,547

(22) Filed: Dec. 11, 2020

(30) Foreign Application Priority Data
Dec. 11, 2019 (CN) 201911268745.5

(51) Int. Cl. B01D 65/02; C02F 1/44; B01D 61/14; B01D 61/18; B01D 69/02; B01D 69/06; B01D 71/02

(52) U.S. Cl. CPC B01D 65/02; C02F 1/444; B01D 61/145; C02F 2103/10; B01D 69/02; B01D 69/06; B01D 71/02; B01D 61/18

(57) ABSTRACT

The ultrafiltration system for treatment of coal mine water includes an intermediate water pool, an ultrafiltration membrane pool, an adjustment pool, a water production pool, and a water removal pool; wherein the ultrafiltration membrane pool is connected to the intermediate water pool through a water inlet valve and a water inlet pump, connected to the water production pool through a backwashing valve and a backwashing pump, and connected to the water removal pool through a water production valve and water production pump, and the adjustment pool is connected to the ultrafiltration membrane pool; and an ultrafiltration membrane assembly and a cleaning device are disposed in the ultrafiltration membrane pool, an aeration tube is disposed in the ultrafiltration membrane pool below the ultrafiltration membrane assembly, the aeration tube is connected to a blower, and a water production channel in a ceramic membrane assembly is connected to the water production pool.

### CROSS-REFERENCE TO RELATED APPLICATIONS

This application claims priority of Chinese Patent Application No. 201911268745.5, filed on Dec. 11, 2019, entitled “ULTRAFILTRATION SYSTEM FOR ADVANCED TREATMENT OF COAL MINE WATER”, the contents of which is expressly incorporated herein by reference in its entirety.

### TECHNICAL FIELD

The present technology belongs to the field of water treatment and relates to treatment of coal mine water, and specifically to an ultrafiltration system for advanced treatment of coal mine water.

### BACKGROUND

Plenty of mine water are produced during exploitation and excavation of coal. Under the impact of underground mining and human activities, the mine water contains a lot of impurities such as rock powder and mineral powder, and also contains a small quantity of organisms and microorganisms. If the mine water is directly discharged without treatment, on one hand, water source in a mine area is polluted, and on the other hand, the ecological environment in the mine area is destroyed.

Currently, Coagulation-sedimentation and filtration processes are mainly adopted to treat mine water. After such processes, the effluent quality can reach the originally formulated effluent standard of “Code for design of the fire protecting, sprinkling system in underground coalmine” (GB 50383-2016). However, with increasingly severe environment protection situation, a higher discharge standard for mine wastewater treatment is proposed. In order to ensure that discharged mine water steadily reaches the standard of class III of surface water, it is necessary to perform advanced treatment on water treated by an original treatment system, to further reduce content of pollutants in the water and finally reach the new discharge standard.

The inorganic ceramic membrane is a type of inorganic material with a special selective separation function that can separate a fluid into two disconnected parts. One or several types of materials can permeate the inorganic ceramic membrane, so as to separate other materials. With characteristics such as high-efficiency, energy conservation, environment friendliness, and molecule-scale filtration, the separation technology of the inorganic ceramic membrane has been wildly applied to the fields such as medicine, water treatment, chemical industry, electronics, and food processing, and is acknowledged as one of most important industry technologies in the 21st century. However, there is no report on the inorganic ceramic membrane being applied to coal mine water treatment. Besides, during coal mine water treatment, as time going by, fine coal powder not coagulated and sedimented in the mine water flows into hole paths of the ceramic membrane, to cause blockage of the ceramic membrane in different degrees, thereby affecting the water production efficiency. Therefore, the existing inorganic ceramic membrane technology cannot be applied to the mine water treatment.

### SUMMARY

The objective of the present technology is to resolve the problem of the quality of discharged effluent water in the existing coal mine water treatment process, and provide an ultrafiltration system for advanced treatment of coal mine water.

The present technology is realized by the following technical solution:

An ultrafiltration system for advanced treatment of coal mine water is provided, including an intermediate water pool, an ultrafiltration membrane pool, an adjustment pool, a water production pool, and a water removal pool;

wherein the ultrafiltration membrane pool is connected to the intermediate water pool through a water inlet valve and a water inlet pump, connected to the water production pool through a backwashing valve and a backwashing pump, and connected to the water removal pool through a water production valve and water production pump, and the adjustment pool is connected to the ultrafiltration membrane pool through a drain valve disposed at a bottom of a side surface of the ultrafiltration membrane pool; and

an ultrafiltration membrane assembly and a cleaning device are disposed in the ultrafiltration membrane pool, an aeration tube is disposed in the ultrafiltration membrane pool below the ultrafiltration membrane assembly, the aeration tube is connected to a blower through an intake valve, and a water production channel in a ceramic membrane assembly is connected to the water production pool through a pipe.

Further, an overflow pipe is disposed on a side wall above the ultrafiltration membrane pool, and the overflow pipe is connected to the adjustment pool.

The cleaning device is an ultrasonic generator, and is used in cooperation with a backwashing device; a working current of the cleaning device can be adjusted.

The cleaning device is mounted on the side wall of the ultrafiltration membrane pool, and removes or loosens pulverized coal particles blocking hole paths of the ultrafiltration membrane with ultrasonication.

The ultrafiltration membrane assembly is a flat-sheet ceramic membrane with an aperture of 100 nm to 200 nm.

A quantity of the flat-sheet ceramic membrane is one or more group. The quantity of the ultrafiltration membrane assembly may be adjusted according to a size of the ultrafiltration membrane pool and the water production speed.

A liquid level indicator is disposed on a side wall at an upper part of the ultrafiltration membrane pool.

During operation, the water inlet valve and the water inlet pump are turned on at first. Water being treated by front-end coagulation-sedimentation flows into the ultrafiltration membrane pool. When a water level in the ultrafiltration membrane pool reaches a designated water level and when the water overflows an ultrafiltration membrane, the water production valve and the water production pump are turned on sequentially. Under the negative pressure of the water production pump, the upstream water flows into a water production device through the ultrafiltration membrane and starts to produce water. Until the membrane flux of the ultrafiltration system is less than a specific value, it is considered that the membrane starts to be blocked. In this case, the ultrafiltration membrane starts to be cleaned. The water production pump, the water production valve, the water inlet pump, and the water inlet valve are turned off sequentially. The ultrasonic cleaning device is turned on and the working current is adjusted. After a period of ultrasonication, the ultrasonic cleaning device is turned off. The intake valve and the blower are turned on sequentially to start aeration, and the drain valve is turned on at the same time to discharge the sewage in the ultrafiltration system which free flows, under gravity, into the front-end adjustment pool. After all the sewage is discharged, the drain valve is turned off. The backwashing valve and the backwashing pump are turned on sequentially. Backwashing water reverses through the ceramic membrane from the water production device to perform backwashing. After the backwashing, the backwashing pump, the backwashing valve, the blower, and the intake valve are turned off sequentially. Then the water inlet valve and the water inlet pump are turned on to start a second-round water production.

In order to verify effects of the present technology, the impact of ultrasonication time on the membrane flux is measured, and the result is shown in FIG. 2; the impact of the current of the ultrasonic cleaning device on the membrane flux is measured, and the result is shown in FIG. 3. An optimal ultrasonication time and current can be obtained from the results shown in FIG. 2 and FIG. 3.

The present technology is of a simple structure and is convenient to operate; no chemical reagent is needed during operation to implement quick cleaning and regeneration of the ceramic membrane, greatly improving the water production efficiency of the system.

### BRIEF DESCRIPTION OF THE DRAWINGS

FIG. 1 is a schematic structural diagram of the present technology;

FIG. 2 shows an impact of an ultrasonication time on a membrane flux; and

FIG. 3 shows an impact of a current of an ultrasonic cleaning device on a membrane flux.

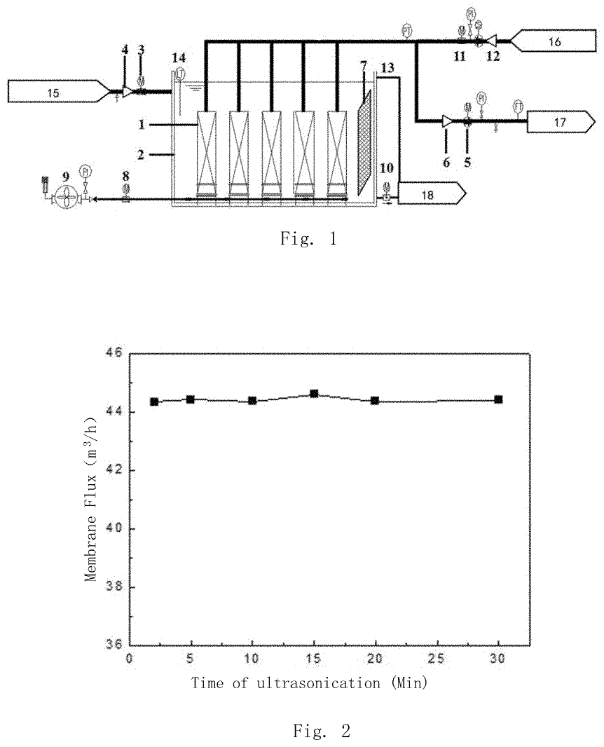

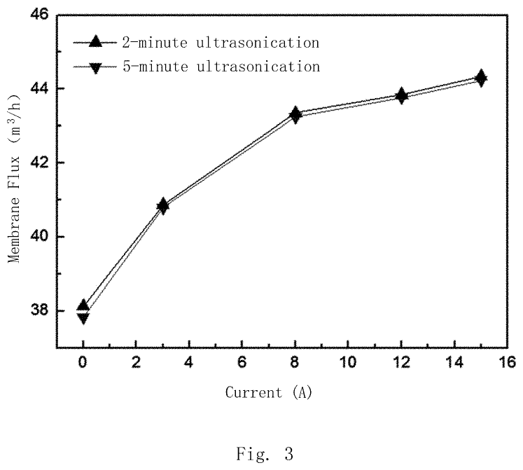

In the drawings: 1—ultrafiltration membrane assembly, 2—ultrafiltration membrane pool, 3—water inlet valve, 4—water inlet pump, 5—water production valve, 6—water production pump, 7—cleaning device, 8—intake valve, 9—blower, 10—drain valve, 11—backwashing valve, 12—backwashing pump, 13—overflow pipe, 14—liquid level indicator, 15—intermediate water pool, 16—water production pool, 17—water removal pool, 18—adjustment pool.

### DETAILED DESCRIPTION

The present technology is further described below with reference to embodiments and the accompanying drawings.

### Embodiment 1

An ultrafiltration system for advanced treatment of coal mine water as shown in FIG. 1 includes an intermediate water pool, an ultrafiltration membrane pool 2, an adjustment pool, a water production pool, and a water removal pool. The ultrafiltration membrane pool 2 is connected to the intermediate water pool 15 through a water inlet valve 3 and a water inlet pump 4, connected to the water production pool 16 through a backwashing valve 11 and a backwashing pump 12, and connected to the water removal pool 17 through a water production valve 5 and a water production pump 6. The adjustment pool 18 is connected to the ultrafiltration membrane pool 2 through a drain valve 10 disposed at a bottom of a side surface of the ultrafiltration membrane pool. An ultrafiltration membrane assembly 1 (which is an assembly formed by the ceramic membrane) is disposed in the ultrafiltration membrane pool 2. A cleaning device 7—ultrasonic generator is mounted on a side wall of the ultrafiltration membrane pool 2. An aeration tube is disposed in the ultrafiltration membrane pool below the ultrafiltration membrane assembly. The aeration tube is connected to a blower 9 through an intake valve 8. A water production channel in the ceramic membrane assembly 1 is connected to the water production pool 16 through a pipe.

During operation, the chemical oxygen demand (CODCr) of the quality of mine water in mine #1 after coagulation-sedimentation is 30.5 mg/L, the content of ammonia-nitrogen is 1.12 mg/L, the turbidity is 2.34 NTU, and the content of petroleum-like substance is 0.06 mg/L. The water flows into the ultrafiltration system for filtration. The average aperture of the ceramic membrane is 200 nm. The frequency of the water production pump is 30 Hz. The initial membrane flux is 45.8 m3/h. After the filtration of the ultrafiltration system, most of suspensions and organisms including petroleum-like substances are removed. The CODCr of the effluent quality is reduced to 13.6 mg/L, the turbidity is reduced to 0.26 NTU, and the content of petroleum-like substance is reduced to 0.03 mg/L. After the system operates for 36 hours, the membrane flux is reduced to 35.0 m3/h. At this time, the ceramic membrane starts to be cleaned.

During cleaning, at first, the water production pump, the water production valve, the water inlet pump, and the water inlet valve are turned off sequentially. The ultrasonic cleaning device is turned on with a frequency of 40 MHz and a working current of 15 A. The ultrasonic cleaning device is turned off after 10-minute ultrasonication. The intake valve and the blower are turned on sequentially to start aeration, and the drain valve is turned on at the same time to discharge the sewage in the ultrafiltration system into the front-end treatment system. After all the sewage is discharged, the drain valve is turned off. The backwashing valve and the backwashing pump are turned on sequentially to start 4-minute backwashing. After the backwashing, the backwashing pump, the backwashing valve, the blower, and the intake valve are turned off sequentially. Then the water inlet valve and the water inlet pump are turned on. When a water level in the ultrafiltration membrane pool reaches a designated water level and when the water overflows the ultrafiltration membrane, the water production valve and the water production pump are turned on sequentially to start a second-round water production. At this time, the membrane flux restores to 45.6 m3/h. The system has operated for 127 days with such a recycle, and is cleaned once a day. The effluent quality still meets the Class III standard of environmental quality standards for surface water, and the membrane flux maintains within 44.5±1.6 m3/h (a designed flux is 50.0 m3/h).

### Embodiment 2

An ultrafiltration system for advanced treatment of coal mine water as shown in FIG. 1 includes an intermediate water pool, an ultrafiltration membrane pool 2, an adjustment pool, a water production pool, and a water removal pool. The ultrafiltration membrane pool 2 is connected to the intermediate water pool 15 through a water inlet valve 3 and a water inlet pump 4, connected to the water production pool 16 through a backwashing valve 11 and a backwashing pump 12, and connected to the water removal pool 17 through a water production valve 5 and water production pump 6. An overflow pipe 13 is disposed on a side wall at an upper part of the ultrafiltration membrane pool 2. The overflow pipe 13 is connected to the adjustment pool 18. The adjustment pool 18 is connected to the ultrafiltration membrane pool 2 through a drain valve 10 disposed at a bottom of a side surface of the ultrafiltration membrane pool. An ultrafiltration membrane assembly 1 (which is an assembly formed by the ceramic membrane) is disposed in the ultrafiltration membrane pool 2. A cleaning device 7—ultrasonic generator and a liquid level indicator 14 are mounted on a side wall of the ultrafiltration membrane pool 2. An aeration tube is disposed in the ultrafiltration membrane pool below the ultrafiltration membrane assembly. The aeration tube is connected to a blower 9 through an intake valve 8. A water production channel in the ceramic membrane assembly 1 is connected to the water production pool 16 through a pipe.

During operation, CODCr of the quality of mine water in mine #2 after coagulation-sedimentation is 42.6 mg/L, the content of ammonia-nitrogen is 1.07 mg/L, the turbidity is 5.61 NTU, and the content of petroleum-like substance is 0.07 mg/L. The water flows into the ultrafiltration system for filtration. The average aperture of the ceramic membrane is 150 nm. The frequency of the water production pump is 30 Hz. The initial membrane flux is 43.6 m3/h. After the filtration of the ultrafiltration system, most of suspensions and organisms including petroleum-like substances are removed. The CODCr of the effluent quality is reduced to 11.4 mg/L, the turbidity is reduced to 0.42 NTU, and the content of petroleum-like substance is reduced to 0.04 mg/L. After the system operates for 29 hours, the membrane flux is reduced to 35.0 m3/h. At this time, the ceramic membrane starts to be cleaned.

During cleaning, at first, the water production pump, the water production valve, the water inlet pump, and the water inlet valve are turned off sequentially. The ultrasonic cleaning device is turned on with a frequency of 40 MHz and a working current of 12 A. The ultrasonic cleaning device is turned off after 20-minute ultrasonication. The intake valve and the blower are turned on sequentially to start aeration, and the drain valve is turned on at the same time to discharge the sewage in the ultrafiltration system into the front-end treatment system. After all the sewage is discharged, the drain valve is turned off. The backwashing valve and the backwashing pump are turned on sequentially to start 4-minute backwashing. After the backwashing, the backwashing pump, the backwashing valve, the blower, and the intake valve are turned off sequentially. Then the water inlet valve and the water inlet pump are turned on. When a water level in the ultrafiltration membrane pool reaches a designated water level and when the water overflows the ultrafiltration membrane, the water production valve and the water production pump are turned on sequentially to start a second-round water production. At this time, the membrane flux restores to 42.7 m3/h. The system has operated for 114 days with such a recycle, and is cleaned once a day. The effluent quality still meets the Class III standard of environmental quality standards for surface water, and the membrane flux maintains within 43.1±1.4 m3/h (designed flux is 50.0 m3/h).

### Embodiment 3

An ultrafiltration system for advanced treatment of coal mine water as shown in FIG. 1 includes an intermediate water pool, an ultrafiltration membrane pool 2, an adjustment pool, a water production pool, and a water removal pool. The ultrafiltration membrane pool 2 is connected to the intermediate water pool 15 through a water inlet valve 3 and a water inlet pump 4, connected to the water production pool 16 through a backwashing valve 11 and a backwashing pump 12, and connected to the water removal pool 17 through a water production valve 5 and water production pump 6. An overflow pipe 13 is disposed on a side wall at an upper part of the ultrafiltration membrane pool 2. The overflow pipe 13 is connected to the adjustment pool 18. The adjustment pool 18 is connected to the ultrafiltration membrane pool 2 through a drain valve 10 disposed at a bottom of a side surface of the ultrafiltration membrane pool. An ultrafiltration membrane assembly 1 (which is an assembly formed by the ceramic membrane) is disposed in the ultrafiltration membrane pool 2. A cleaning device 7—ultrasonic generator and a liquid level indicator 14 are mounted on a side wall of the ultrafiltration membrane pool 2. An aeration tube is disposed in the ultrafiltration membrane pool below the ultrafiltration membrane assembly. The aeration tube is connected to a blower 9 through an intake valve 8. A water production channel in the ceramic membrane assembly 1 is connected to the water production pool 16 through a pipe.

CODCr of the quality of mine water in mine #3 after coagulation-sedimentation is 27.9 mg/L, the content of ammonia-nitrogen is 1.03 mg/L, the turbidity is 3.38 NTU, and the content of petroleum-like substance is 0.06 mg/L. The water flows into the ultrafiltration system for filtration. The average aperture of the ceramic membrane is 200 nm. The frequency of the water production pump is 30 Hz. The initial membrane flux is 46.3 m3/h. After the filtration of the ultrafiltration system, most of suspensions and organisms including petroleum-like substances are removed. The CODCr of the effluent quality is reduced to 8.9 mg/L, the turbidity is reduced to 0.21 NTU, and the content of petroleum-like substance is reduced to 0.03 mg/L. After the system operates for 32 hours, the membrane flux is reduced to 35.0 m3/h. At this time, the ceramic membrane starts to be cleaned.

During cleaning, at first, the water production pump, the water production valve, the water inlet pump, and the water inlet valve are turned off sequentially. The ultrasonic cleaning device is turned on with a frequency of 40 MHz and a working current of 10 A. The ultrasonic cleaning device is turned off after 25-minute ultrasonication. The intake valve and the blower are turned on sequentially to start aeration, and the drain valve is turned on at the same time to discharge the sewage in the ultrafiltration system into the front-end treatment system. After all the sewage is discharged, the drain valve is turned off. The backwashing valve and the backwashing pump are turned on sequentially to start 4-minute backwashing. After the backwashing, the backwashing pump, the backwashing valve, the blower, and the intake valve are turned off sequentially. Then the water inlet valve and the water inlet pump are turned on. When a water level in the ultrafiltration membrane pool reaches a designated water level and when the water overflows the ultrafiltration membrane, the water production valve and the water production pump are turned on sequentially to start a second-round water production. At this time, the membrane flux restores to 45.9 m3/h. The system has operated for 139 days with such a recycle, and is cleaned once a day. The effluent quality still meets the Class III standard of environmental quality standards for surface water, and the membrane flux maintains within 46.1±1.1 m3/h (designed flux is 50.0 m3/h).

### Embodiment 4

An ultrafiltration system for advanced treatment of coal mine water as shown in FIG. 1 includes an intermediate water pool, an ultrafiltration membrane pool 2, an adjustment pool, a water production pool, and a water removal pool. The ultrafiltration membrane pool 2 is connected to the intermediate water pool 15 through a water inlet valve 3 and a water inlet pump 4, connected to the water production pool 16 through a backwashing valve 11 and a backwashing pump 12, and connected to the water removal pool 17 through a water production valve 5 and water production pump 6. An overflow pipe 13 is disposed on a side wall at an upper part of the ultrafiltration membrane pool 2. The overflow pipe 13 is connected to the adjustment pool 18. The adjustment pool 18 is connected to the ultrafiltration membrane pool 2 through a drain valve 10 disposed at a bottom of a side surface of the ultrafiltration membrane pool. An ultrafiltration membrane assembly 1 (which is an assembly formed by the ceramic membrane) is disposed in the ultrafiltration membrane pool 2. A cleaning device 7—ultrasonic generator and a liquid level indicator 14 are mounted on a side wall of the ultrafiltration membrane pool 2. An aeration tube is disposed in the ultrafiltration membrane pool below the ultrafiltration membrane assembly. The aeration tube is connected to a blower 9 through an intake valve 8. A water production channel in the ceramic membrane assembly 1 is connected to the water production pool 16 through a pipe.

CODCr of the quality of mine water in mine #4 after coagulation-sedimentation is 15.4 mg/L, the content of ammonia-nitrogen is 0.86 mg/L the turbidity is 1.49 NTU, and the content of petroleum-like substance is 0.05 mg/L. The water flows into the ultrafiltration system for filtration. The average aperture of the ceramic membrane is 100 nm. The frequency of the water production pump is 30 Hz. The initial membrane flux is 47.4 m3/h. After the filtration of the ultrafiltration system, most of suspensions and organisms including petroleum-like substances are removed. The CODCr of the effluent quality is reduced to 4.6 mg/L, the turbidity is reduced to 0.16 NTU, and the content of petroleum-like substance is reduced to 0.02 mg/L. After the system operates for 45 hours, the membrane flux is reduced to 35.0 m3/h. At this time, the ceramic membrane starts to be cleaned.

At first, the water production pump, the water production valve, the water inlet pump, and the water inlet valve are turned off sequentially. The ultrasonic cleaning device is turned on with a frequency of 40 MHz and a working current of 8 A. The ultrasonic cleaning device is turned off after 5-minute ultrasonication. The intake valve and the blower are turned on sequentially to start aeration, and the drain valve is turned on at the same time to discharge the sewage in the ultrafiltration system into the front-end treatment system. After all the sewage is discharged, the drain valve is turned off. The backwashing valve and the backwashing pump are turned on sequentially to start 4-minute backwashing. After the backwashing, the backwashing pump, the backwashing valve, the blower, and the intake valve are turned off sequentially. Then the water inlet valve and the water inlet pump are turned on. When a water level in the ultrafiltration membrane pool reaches a designated water level and when the water overflows the ultrafiltration membrane, the water production valve and the water production pump are turned on sequentially to start a second-round water production. At this time, the membrane flux restores to 46.7 m3/h. The system has operated for 198 days with such a recycle, and is cleaned once a day. The effluent quality still meets the Class III standard of environmental quality standards for surface water, and the membrane flux maintains within 47.2±1.3 m3/h (designed flux is 0.0 m3/h).

The quality of water of mines #1-4 that flows through the ultrafiltration system is measured. The results are shown in Table 1.

TABLE 1
Detection results of the effluent quality of mine water in each mine (mg/L)

| | | Limit value | | | | |
|---|---|---|---|---|---|---|
| | | of class | | | | |
| | | III of | | | | |
| | | surface | Mine | Mine | Mine | Mine |
| No. | Indicator | water | #1 | #2 | #3 | #4 |
| 1 | pH | 6-9 | 7.34 | 7.94 | 7.75 | 7.66 |
| | (dimension- | | | | | |
| | less) | | | | | |
| 2 | Dissolved | 5 | 6.5 | 7.1 | 6.9 | 8.2 |
| | oxygen | | | | | |
| 3 | Permanganate | 6 | 0.85 | 1.17 | 1.28 | 1.23 |
| | index | | | | | |
| 4 | Chemical | 20 | 3.755 | 11.36 | 6.012 | 3.010 |
| | Oxygen | | | | | |
| | Demand | | | | | |
| | COD_{Cr} | | | | | |
| 5 | Biological | 4 | 2.2 | 3.1 | 2.6 | 1.8 |
| | Oxygen | | | | | |
| | Demand for | | | | | |
| | 5 days | | | | | |
| | BOD₅ | | | | | |
| 6 | NH₃-N | 1 | 0.468 | 0.030 | 0.014 | 0.066 |
| | (ammonia | | | | | |
| | nitrogen) | | | | | |
| 7 | Total | 0.2 | 0.011 | 0.021 | 0.005 | 0.114 |
| | phosphorus | | | | | |
| 8 | Total | 1 | 0.876 | 0.895 | 0.765 | 0.785 |
| | nitrogen | | | | | |
| 9 | Fluoride | 1 | 0.394 | 0.437 | 0.650 | 0.593 |
| 10 | Se | 0.01 | 0.006 | 0.006 | 0.008 | 0.009 |
| 11 | As | 0.05 | ND | ND | ND | ND |
| 12 | Hg | 0.0001 | ND | ND | ND | ND |
| 13 | Cr (VI) | 0.05 | ND | 0.012 | 0.021 | 0.017 |
| 14 | Cu | 1 | ND | ND | ND | ND |
| 15 | Zn | 1 | 0.036 | ND | 0.014 | HD |
| 16 | Pb | 0.05 | ND | ND | ND | ND |
| 17 | Cd | 0.005 | ND | ND | ND | ND |
| 18 | Cyanide | 0.02 | 0.005 | 0.005 | 0.011 | 0.005 |
| 19 | Volatile | 0.005 | ND | ND | ND | ND |
| | phenols | | | | | |
| 20 | Petroleum- | 0.05 | 0.02 | ND | ND | 0.02 |
| | like | | | | | |
| 21 | Anionic | 0.2 | ND | ND | ND | ND |
| | surfactant | | | | | |
| 22 | Sulfide | 0.2 | ND | ND | ND | ND |
| 22 | Fecal | 10000 | 70 | 31 | 35 | 46 |
| | coliforms | | | | | |
| | (number/L) | | | | | |

1. An ultrafiltration system for advanced treatment of coal mine water, comprising:
an intermediate water pool;
an ultrafiltration membrane pool;
an adjustment pool;
a water production pool; and
a water removal pool, wherein the ultrafiltration membrane pool is connected to the intermediate water pool through a water inlet valve and a water inlet pump, connected to the water production pool through a backwashing valve and a backwashing pump, and connected to the water removal pool through a water production valve and water production pump, and the adjustment pool is connected to the ultrafiltration membrane pool through a drain valve disposed at a bottom of a side surface of the ultrafiltration membrane pool; and
a ceramic membrane assembly and a cleaning device are disposed in the ultrafiltration membrane pool, an aeration tube is disposed in the ultrafiltration membrane pool below the ultrafiltration membrane assembly, the aeration tube is connected to a blower through an intake valve, and a water production channel in the ceramic membrane assembly is connected to the water production pool through a pipe.

2. The ultrafiltration system for advanced treatment of coal mine water of claim 1, wherein an overflow pipe is disposed on a side wall at an upper part of the ultrafiltration membrane pool, and the overflow pipe is connected to the adjustment pool.

3. The ultrafiltration system for advanced treatment of coal mine water of claim 1, wherein the cleaning device is an ultrasonic generator.

4. The ultrafiltration system for advanced treatment of coal mine water of claim 2, wherein the cleaning device is an ultrasonic generator.

5. The ultrafiltration system for advanced treatment of coal mine water of claim 1, wherein the cleaning device is mounted on the side wall of the ultrafiltration membrane pool.

6. The ultrafiltration system for advanced treatment of coal mine water of claim 2, wherein the cleaning device is mounted on the side wall of the ultrafiltration membrane pool.

7. The ultrafiltration system for advanced treatment of coal mine water of claim 1, wherein the ultrafiltration membrane assembly is a flat-sheet ceramic membrane with an aperture of 100 nm to 200 nm.

8. The ultrafiltration system for advanced treatment of coal mine water of claim 2, wherein the ultrafiltration membrane assembly is a flat-sheet ceramic membrane with an aperture of 100 nm to 200 nm.

9. The ultrafiltration system for advanced treatment of coal mine water of claim 1, wherein a quantity of the flat-sheet ceramic membrane is one or more group.

10. The ultrafiltration system for advanced treatment of coal mine water of claim 2, wherein a quantity of the flat-sheet ceramic membrane is one or more group.

11. The ultrafiltration system for advanced treatment of coal mine water of claim 1, wherein a liquid level indicator is disposed on a side wall at an upper part of the ultrafiltration membrane pool.

12. The ultrafiltration system for advanced treatment of coal mine water of claim 2, wherein a liquid level indicator is disposed on a side wall at an upper part of the ultrafiltration membrane pool.
